(19) United States
(12) Patent Application Publication
(10) Pub. No.: US 2006/0171625 A1
(43) Pub. Date: Aug. 3, 2006

(54) Method and apparatus for sensing the condition of a device, process material or structure

(76) Inventors: Barry E Jones, Middlesex (GB); Yuen Hong Joseph Au, Middesex (GB); Ryszard Tadeusz Rakowski, Middlesex (GB); Tomphong Kaewkongka, Middlesex (GB)

Correspondence Address: Craig A. Fieschko;DeWitt Ross &I Stevens, 8000 Excelsior Drive, Suite 401, Madison, WI, 53717-1914, US

(21) Appl. No.: 10/551,155

(22) PCT Filed: Mar. 26, 2004
(86) PCT No.: PCT/GB04/01332

§ 371 Date: Sep. 28, 2005

(30) Foreign Application Priority Data
Mar. 28, 2003 (GB) 0307312.9

(51) Int. Cl. F16C 41/00

(52) U.S. Cl. 384/624

(57) ABSTRACT

A system for determining the condition of a device or process uses the inter-arrival times of successive acoustic emission events generated by the device or process being monitored. From this measurement, the system determines a statistical distribution, preferably a Weibull distribution, to determine a shape to life parameter for characterizing the device or process being monitored. The system allows a simple and effective determination of the condition of a device or process, taking into account operating conditions and which can monitor also the state of healthy components.

The present invention relates to a method and system for monitoring the condition of a process, material, structure, a device or of part of a device. The preferred embodiments disclosed herein provide for the monitoring of components of an assembly, specific mention being made of bearings.

Process and apparatus monitoring systems have been known for a long time. Their purpose is not only to determine if a process or apparatus are functioning as they should but also to try to detect failure in any part of the process or apparatus. Such failure might not be immediately noticed by an operator or from an output of the device or process. Moreover, some failures can have catastrophic consequences on a process or performance of a device and it is therefore advantageous to try to detect any early signs of failures before they actually occur.

For this purpose, systems are known for measuring the performance of components of a device, measuring for example energy expended, amplitude of sensory outputs and the like. However, a common problem with most prior art methods is that they only trigger an alarm close to or at the point of failure of a component of a device. Often, this is late, causing shut down of the device at inappropriate times and possibly delays in repair because of the lack of sufficient warning. In a manufacturing or operations environment this can be very disadvantageous.

An example application is in monitoring the condition of bearings. Generally, two principal methods of decreasing the risk of bearing failure are used: a) statistical bearing life estimation and b) bearing condition monitoring and diagnosis. Statistical bearing life estimation predicts the fatigue life of a bearing and either builds in substantial over-design in terms of design life, or increases the frequency of a planned preventative maintenance programme where the bearing may be renewed or overhauled.

In certain applications (for example, where the bearing is in a harsh environment or is subject to large fluctuating loads) using over-design or having a preventative maintenance and inspection programme will have limitations as failure can be become unpredictable. For these applications bearing condition and diagnosis can be a very reliable method to reduce the risk of unexpected failure because it seeks to provide up-to-date information about the condition of a bearing. The most popular approaches used are vibration, oil analysis and thermographic imaging. In some specialised casesacoustic emission analyses is used. Vibration methods have been shown to be effective for bearing condition monitoring at higher rotating speeds. However, almost all current techniques cannot cope with low speed applications, for which it has been found that this new acoustic emission method can be used. Prior art acoustic emission monitoring methods have failed to provide sufficiently robust condition monitoring products for the industry as prior art acoustic emission monitoring is very sensitive and in application there are problems with gaining repeatable results in any given application as well as producing systems that can give compatibility of results between applications.

Furthermore conventional vibration, thermographic imaging and oil analysis based condition monitoring methods generally will only demonstrate a deteriorating environment that could well have seen the bearing damaged to some extent.

The present invention seeks to provide an improved system and method for detecting the condition or performance of a device, process, material or structure. The preferred embodiments allow reliable monitoring at an earlier stage in the life reduction that may be caused by, for example, poor lubrication, mis-aligmnent, wear or fatigue

In addition the preferred embodiments seek to provide an improved acoustic emission monitoring method compared to the prior art by offering both repeatability of results and compatibility of results between systems, that the existing systems are not able to give.

According to an aspect of the present invention, there is provided a method of determining the condition of a device, process, material or structure including the steps of measuring acoustic emissions from the device or process, determining inter-arrival times of acoustic emission events; determining a statistical distribution of the inter-arrival times and therefrom statistical parameters characterising the distribution, using the statistical parameters as an indication of the condition of the device or process being monitored.

Preferably, the statistical parameters are obtained using parameter estimation.

In the preferred embodiment, a Weibull distribution is used. In other embodiments, a negative exponential distribution or a hyper-exponential distribution could be used.

Advantageously, a shape to characteristic life distribution is one of the determined parameters, from which the operating condition of a device or process can be determined.

Preferably, the shape to characteristic life parameter is a unit based on inter-arrival times of successive acoustic emission events and is a function of the ratio of the shape factor of the inter-arrival time distribution to the characteristic and guaranteed life in a statistical distribution used to describe the probability of time to failure.

The method preferably monitors trends in changes in the determined parameters over time.

According to another aspect of the present invention, there is provided apparatus for determining the condition of a device, process, material or structure, including at least one sensor operable to measure acoustic emissions from a device or process to be monitored; processing means operable to determine inter-arrival times of acoustic emission events, to determine a statistical distribution of the inter-arrival times and therefrom statistical parameters characterising the distribution and to use the statistical parameters as an indication of the condition of the device or process being monitored; and output means to output the results of the determination to a user.

Preferably, the processing means is operable to obtain the statistical parameters using parameter estimation.

The method and apparatus disclosed herein can provide much more than an indication of imminent failure of a component of a device or process. In its preferred form, the method and system generate a shape to life distribution which can be used to monitor the general condition of a component, even to indicate that the component is functioning correctly and has a long operating life ahead. The method and system can also be used to monitor general operating performance, such as when one or more components are not functioning correctly.

Embodiments of the present invention are described below, by way of example only, with reference to the accompanying drawings, in which:

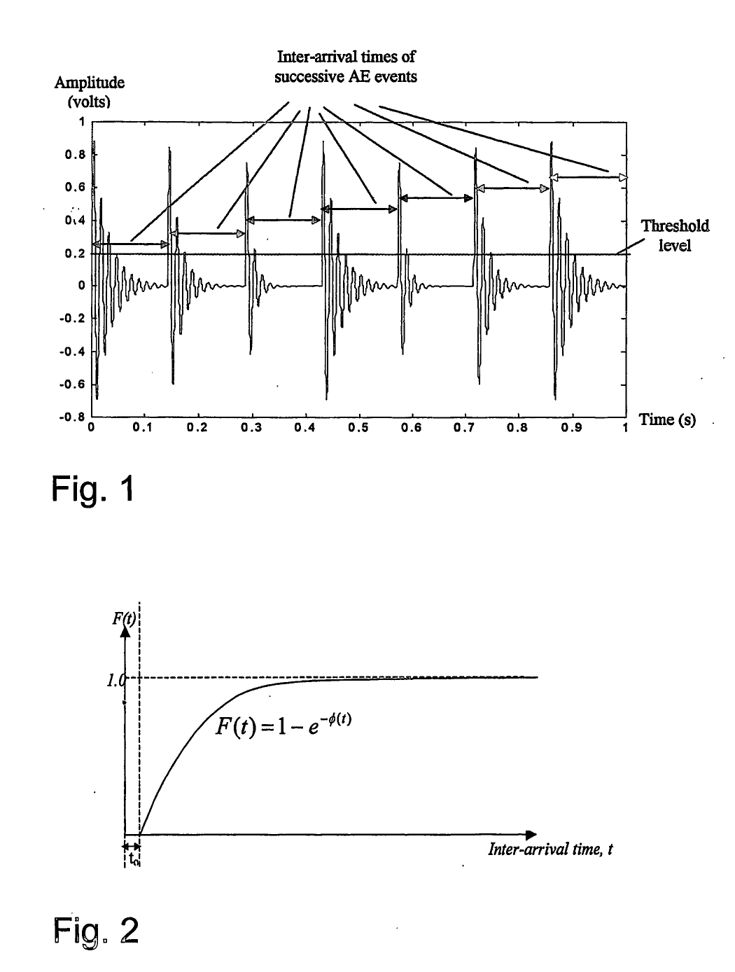

FIG. 1 is a graph showing inter-arrival times of successive acoustic emission events;

FIG. 2 is a graph of cumulative probability of inter-arrival times of AE events;

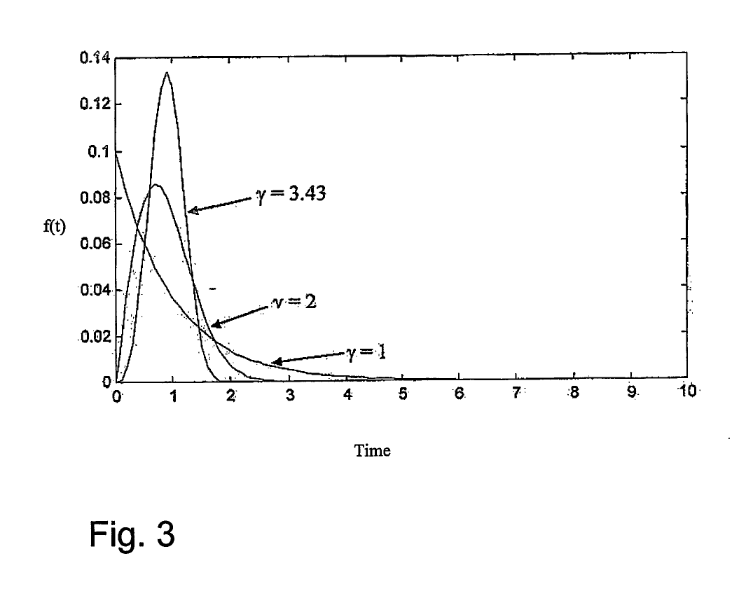

FIG. 3 shows a Weibull distribution with different shape factors showing various patterns of inter-arrival time distribution;

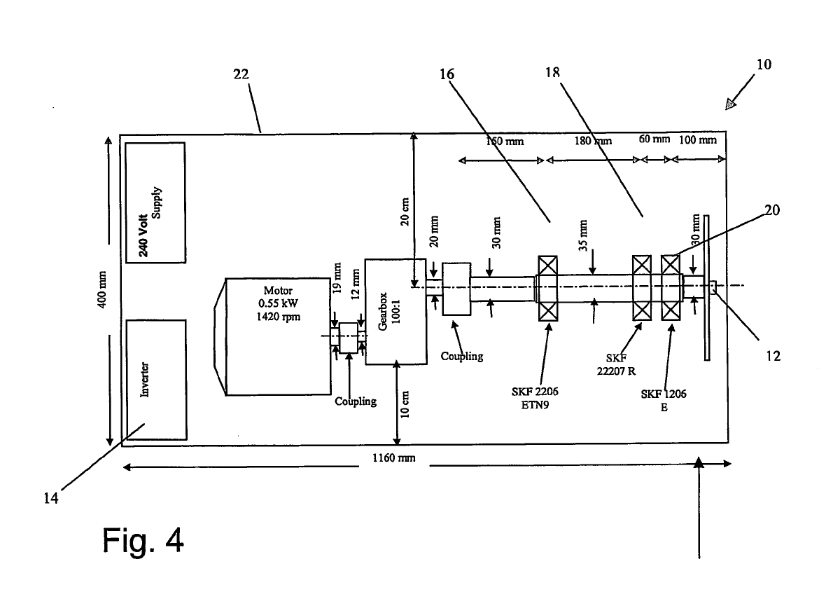

FIG. 4 is a schematic diagram of an embodiment of low-speed heavy-duty test rig;

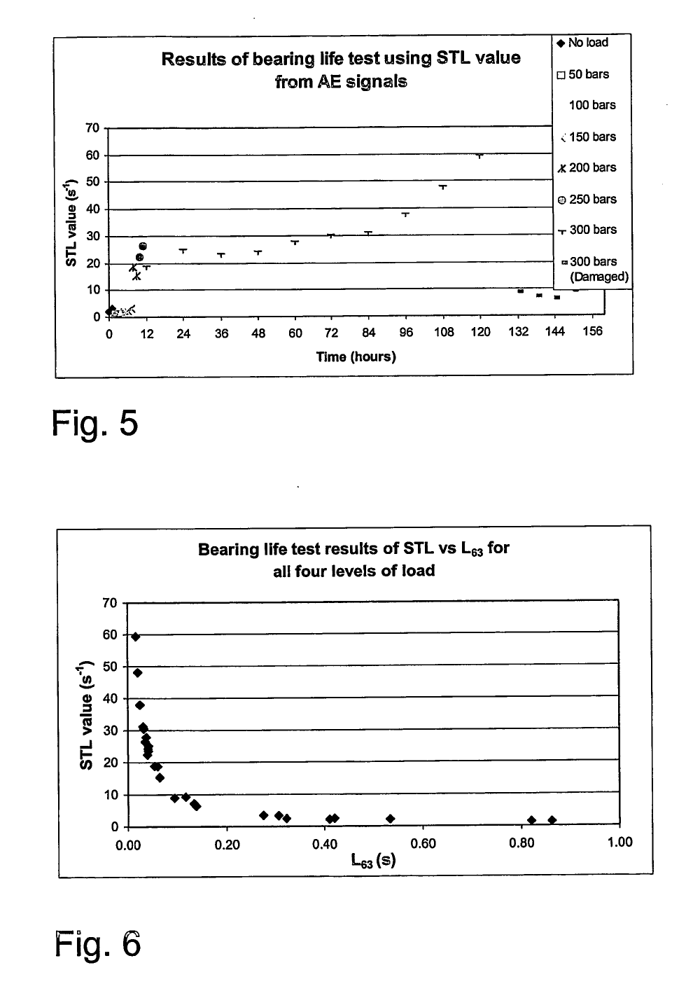

FIG. 5 is a graph showing the progression of STL with time from an example bearing life test;

FIG. 6 is a graph of STL versus L₆₃ from an example bearing life test;

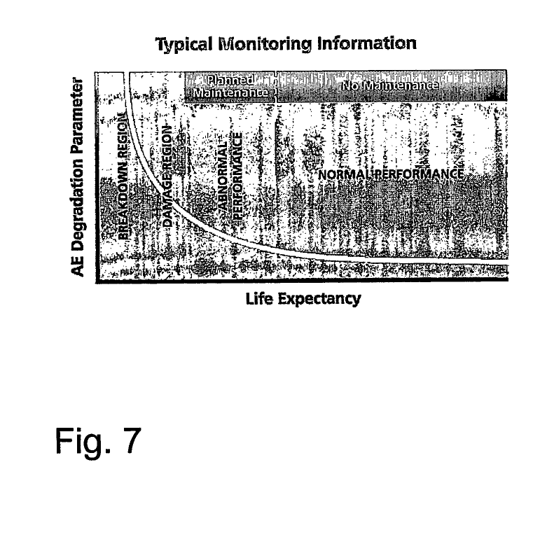

FIG. 7 is a graph provided to give typical monitoring information to a user; and

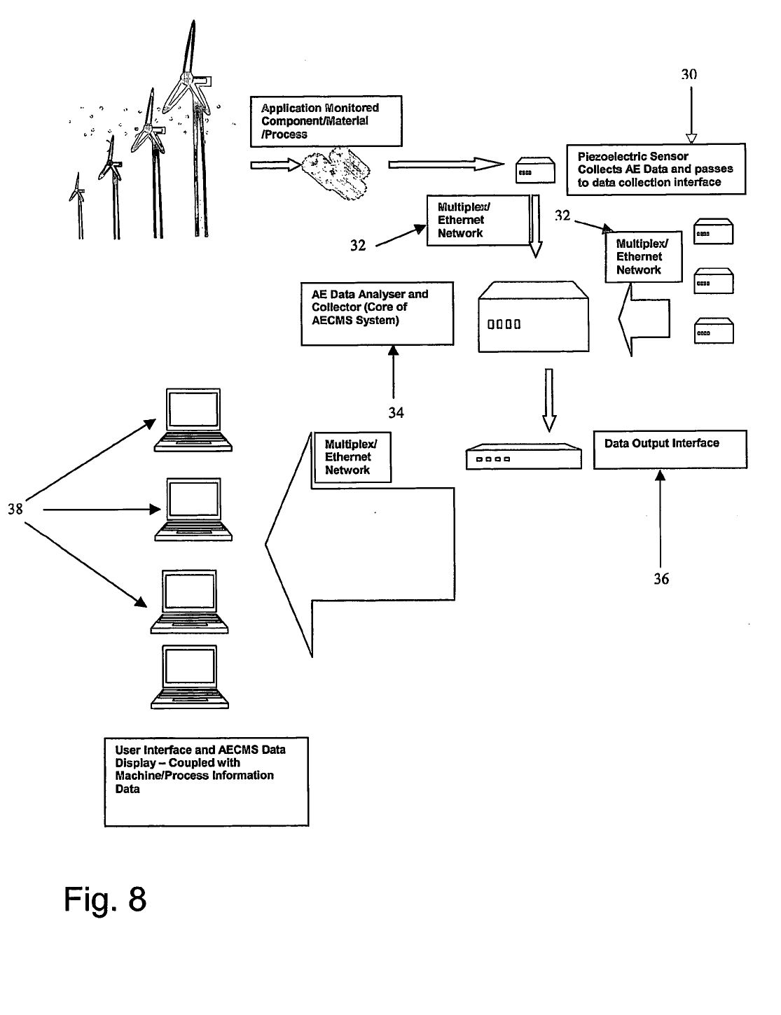

FIG. 8 is a schematic diagram of an example of a multi sensor networked AE conditioning monitoring system set up in a permanent system mode.

The following description focuses on the monitoring of a specific component of an assembly, namely a bearing. This is solely to illustrate the principles of the teachings herein and it will be immediately apparent to a skilled person that the teachings herein could be used in a variety of applications, including but not limited to monitoring the condition of any other component of a device, monitoring the performance of a component in a device, monitoring the performance of a process such as a manufacturing process of the functioning of a machine or other device.

The preferred embodiment described herein focuses on the inter-arrival times of acoustic emission (AE) events which occur during bearing operation, which follow a statistical Weibull distribution. Such a distribution is characterised by three parameters: its shape γ, characteristic life θ and guaranteed life tₒ. In this embodiment, two parameters were derived from the original Weibull parameters, namely:

a) a ratio defined as γ/θ, referred to as the shape-to-life ratio and abbreviated to STL; and

b) a time period, L₆₃, defined as being the sum of θ and tₒ.

Rolling-element bearings, used to describe the principles of the preferred embodiment of the present invention, are very common machine parts found in almost all kinds of rotating machines. A major failure mechanism is the wear process which is often caused by improper, inadequate lubrication or abusive operation. Bearing failure not only increases cost due to production loss and need for repair or replacement but can also threaten safety.

Acoustic emission (AE) is a natural phenomenon of sound generation applied to the spontaneously generated elastic wave produced within a material under stress. Plastic deformation and growth cracks are the primary sources of AE in metals. AE signals can be detected with a piezoelectric transducer, converting surface physical waves into an electrical signal. For rolling-element bearings, a defective roller surface coming into contact with another element produces a transient signal, hereinafter referred to as the AE event, caused by shock impulses at the contacting interface leading to a sudden release of strain energy.

FIG. 1 is a graph showing an AE signal comprising a number of AE events. A dedicated AE measuring instrument, such as the AET5500 manufactured by Babcock and Wilcox or a PCI-2 based AE system manufactured by Physical Acoustics Corporation, captures each event that goes above a predefined threshold and extracts various AE-event characterising parameters together with its time of occurrence. For the purposes of this description, the time difference between two consecutive AE events is referred to as the inter-arrival time.

A high-speed data acquisition system, such as the LABVIEW produced by National Instruments linked to a computer, captures the whole time signal such as that in FIG. 1, from which the inter-arrival times can be extracted, as described herein.

The collection of inter-arrival times forms a distribution which, as will be shown below, has been found to be a Weibull distribution used in reliability studies to model distributions of times-to-failure. In this context, the occurrence of an AE event can be regarded as an instance of failure on a microscopic scale.

The Weibull distribution has been used in reliability engineering to model times-to-failure, as described in Kelly A and Harris M J (1978) Management of Industrial Maintenance, London: Butterworths. It is useful because it has the simple property that a single probability density function can be tailored to fit a time-of-failure distribution irrespective of the underlying different failure modes such as running-in, random and wear-out.

An instance of AE can be considered a kind of failure on a microscopic scale, so the inventors consider the Weibull distribution is most likely to be suitable also for representing the probability of inter-arrival of AE events at a sensor. In this sense, the inter-arrival time is equivalent to time-to-failure. The justification for using the Weibull distribution is presented below, following the line of reasoning developed for time-to-failure distribution.

The cumulative probability, F(t), of inter-arrival times of AE events, by definition, increases monotonically with the time interval t, starting with a probability value of zero at time t=0 and approaching unity as time t tends to infinity. The form of this curve, known as the cumulative probability curve, for mathematical convenience, can be represented by an exponential function as:
F(t)=1−e^{-φ(t)} Equation 1

Equation 1 is represented in graphical form FIG. 2, where it can be seen that φ(t), a function of time t, determines the precise form of the curve.

When an AE event occurs, it occupies a finite time interval during which the occurrence of yet another event cannot be distinguished with an AE measuring instrument. Therefore, the inter-arrival time that can be measured of the subsequent AE event cannot be shorter than the event duration of the current one. In effect, this means that a subsequent detectable event cannot occur in a time less than the event duration of the current one. In the context of cumulative probability F(t), its value has to be zero below some threshold time tₒ, known in reliability engineering as the guaranteed life.

The function φ(t), which defines the precise form of the cumulative probability F(t), should be non-dimensional because it is an exponent of the constant e in Equation 1.

Taking into account all of the foregoing considerations, it is reasonable to suggest that φ(t) takes the form:

$$ϕ ( t ) = {( \frac{t - {t}_{o}}{θ} )}^{γ} ,$$

where tₒ is the guaranteed life, θ the characteristic life, and γ the shape parameter.

Thus, the inter-arrival times have the cumulative distribution function (cdf) given by:

$$F ( t ) = 1 - {ⅇ}^{[ - {( \frac{t - {t}_{o}}{θ} )}^{γ} ]} for t > {t}_{o} , \qquad Equation 2$$

and the corresponding probability density function (pdf) of form:

$$f ( t ) = \frac{γ \cdot ( t - {t}_{o} )}{{θ}^{γ}} \cdot {ⅇ}^{[ - {( \frac{t - {t}_{o}}{θ} )}^{γ} ]} for t > {t}_{o} , \qquad Equation 3$$

It is noted that Equations 2 and 3 describe the cdf and pdf for the Weibull distribution. In these equations (t−tₒ) denotes the ‘quiet’ zone, which marks the time interval between one AE event falling below and the next AE event rising above the threshold.

The parameter θ is referred to as the characteristic life in the Weibull distribution when used to describe the probability of time-to-failure in reliability work. This term is appropriate if, as mentioned before, an AE occurrence is regarded as a microscopic failure. Characteristic life is therefore the characteristic AE inter-arrival time in this context. If the quiet zone (t−tₒ) is as long as the characteristic life θ, then at the inter-arrival time of t=tₒ+θ, the cumulative probability has the value of:
F(tₒ+θ)=1−e⁽⁻¹⁾=0.63.

In other words, if a hundred inter-arrival times were collected, sixty-three would have a value being less than tₒ+θ.

The shape factor, γ, in Equations 2 and 3 is used to express the various patterns of the inter-arrival time distribution, some of which are shown in FIG. 3. For γ=1, the distribution is an exponential distribution. For γ=2, it is a Rayleigh distribution. For γ=3.43, it approximates to a Gaussian distribution.

Once a collection of inter-arrival times of an AB signal is formed, a Weibull distribution is then fitted to it and the Weibull parameters, shape (γ) and characteristic life (θ) and guaranteed life (tₒ), can be estimated. It is noted that γ, being the exponent in Equation 1, is non-dimensional; θ and tₒ have the dimension of time and hence the unit seconds.

Calculation of Shape-to-Life-Ratio and Parameter L₆₃

We define the shape-to-life-ratio, the STL, as the ratio of shape to characteristic life. In symbols, it can be expressed as:

$$STL = \frac{γ}{θ} \qquad Equation 4$$

STL has the unit of s⁻¹.

L₆₃ is defined as the time duration within which 63% of the inter-arrival times of the distribution lies. The L₆₃ duration has a value:
L₆₃=tₒ+θ Equation 5

There has thus been described the inventors' theory on the distribution of inter-arrival times of AE events as being one of the Weibull distribution characterised by the shape parameter γ, the characteristic life θ and the guaranteed life tₒ. From these are defined the STL ratio, as being γ/θ and the L₆₃, being the sum of θ and tₒ.

FIGS. 4 to 6 show an example implementation of monitoring system using the above teachings. In this example, the three original Weibull parameters were estimated from the distribution created from a sample of inter-arrival times of acoustic emission events collected over a time period of about 30 seconds. The estimated values were then used to calculate the corresponding STL and L₆₃. It was observed that at the bearing rotating speed of 13.8 rpm, of radial loads from 0 kN up to 16 kN, and of bearing wear levels from new to failure, the STL and L₆₃ showed a hyperbolic relationship. Among the three influencing variables, the effects of bearing wear on both STL and L₆₃ were the strongest. In every instance, as the level of wear increased, STL increased while L₆₃ decreased. When visualised on a graph of STL versus L₆₃, the point corresponding to the bearing condition moved up the hyperbolic curve.

Referring to FIG. 4, a test rig 10, set up as a ‘low-speed rig’, was designed for different loading conditions and built in order to validate the proposed theory. In this embodiment, a hydraulic radial load could be applied to the rotating shaft 12 while its speed was controlled using an inverter and motor controller 14.

The test rig was composed of a rotating shaft 12 supported at three points 16, 18 and 20: a double-row self-aligned ball bearing at the drive end and a spherical roller bearing at the applied load position and a single row self-aligned ball bearings at the non-drive end.

The shaft 12 had a diameter of 35 mm and was manufactured in steel. The three bearings 16, 18 and 20 were: a double-row self-aligned ball bearing (SKF 2206 ETN9), a spherical roller bearing (SKF 22207 E) and a single row self-aligned ball bearing (SKF 1206 E). The bearings were mounted in bearing housings that in turn were attached to the base plate 22.

The low-speed heavy-duty test rig was run at 0.23 rev/sec. The bearing 20 under test was an SKF 1206E with a maximum load capacity of about 137 bars. AE signals were captured using a wide-band transducer attached to the top of the non-drive end bearing housing. These signals were amplified with a 60 dB gain and filtered with a 100 kHz to 450 kHz band-pass filter. The sampling rate adopted was 1 MHz.

Measurements started with a zero radial load at the test bearing and the load was then increased in 50-bar steps up to 300 bars corresponding to 16 kN. From the loads of 0 to 250 bars, each loading condition was maintained for about 2 hours, thus taking about 12 hours to reach the end of the 250-bar test. Then the load was increased to 300 bars and maintained until the test bearing failed.

The three Weibull parameters of shape γ, characteristic life θ and guaranteed life tₒ. were estimated from the distribution created from a sample of inter-arrival times of acoustic emission events collected over a time period of about 30 seconds. The estimated values were then used to calculate the corresponding STL and L₆₃ using Equations 4 and 5 described above.

FIG. 5 shows the results of the bearing life test and it indicates that the STL values increased when the bearing load was increased in the first twelve hours. With the load then maintained at 300 bars till the 120^{th} hour, the STL increased with progressive bearing wear until the final failure. At the 300-bar load, the STL started with a value of 18.9 and increased monotonically to 59.4 when it failed, representing just over a three-fold increase.

FIG. 6 shows the graph of the STL against L₆₃ for all levels of load applied during the bearing life test. The hyperbolic relationship between STL and L₆₃ is clearly evident.

It has been observed that bearing loads below the recommended load-carrying capacity produce a rather small STL value, typically not more than 8 s⁻¹. The test bearing has a load carrying capacity of 137 bars. This low value of 8 s⁻¹, compared to the range of increase in STL of (59-19) s⁻¹=40 s⁻¹ due to the effect of bearing wear alone for the bearing subjected to a constant load of 300 bars (FIG. 3), is only a fifth.

It therefore seems to suggest that lower bearing loading makes the STL value even more sensitive to bearing wear. In summary, bearing wear exerts a much stronger influence on STL than does the load as long as the latter is kept below the bearing's recommended load carrying capacity.

Speed effects were also studied by running the test rig at 9.46, 14.2 and 28.4 rev/min. The corresponding STL and L₆₃ parameters showed a hyperbolic relationship. In addition, it was noticed that the rotating speed and the inter-arrival time between AE events are inversely proportional to each other. This observation provides a rule for compensating for the speed variation in bearing monitoring.

Thus, in this experiment, the relationship between the two derived parameters, STL and L₆₃, from the inter-arrival time distribution of AE events was observed to be one of a hyperbola irrespective of bearing loads, speeds or wear. Both the STL and L₆₃ values are influenced by wear, speed and bearing loading. Loading values below the recommended load-carrying capacity of the bearing had an insignificant effect on the STL values compared to bearing wear. Bearing speeds exerted a stronger influence on the STL values than did bearing loads but the former could be compensated for properly because it was found to be inversely proportional to the L₆₃ value.

As the skilled person will appreciate, a commercial AE based condition monitoring system that may be sold in a variety of forms. For example, the system may be provided in the form of a separate portable device or may be permanently installed is other apparatus.

A portable system (which may be incorporated into a mini PC, hand held or similar) can be used by engineers on an ad-hoc basis to take trend data reading of machinery, plant, processes or materials on a pre-planned inspection or on an as needed basis. Such a portable system would analyse data and store key trend information for downloading to a central system for processing.

A portable system would enable engineers to plug into predetermined points on a systematic or ad-hoc basis to collect AE data. These points may have embedded or attached sensors in place onto which the portable system is attached.

In a more advanced form, the portable system may have an in-built sensor system that allows the engineer attach the device to pre-determined points on a device to be tested or AE source. Attachment could be aided by the use of magnetic contact pads.

The portable system would allow the local engineer to have more flexibility in choosing the AE reading points. In this example the device would also have an ability to enable the engineer to input data on the data capture positions and attach data to the AE values recorded by the device, enabling data relating to trends to be built up.

An example of permanent AE based condition monitoring system may be configured in an on-line or off line format to monitor single or multiple AE sensor points on an application.

In such a permanent form the system could be provided with a sensor network permanently in place on the plant, process, machine or material being monitored to collect trend data over a period of time.

Data collection and analysis could be in real time or collected on a batch-sampling basis via a network using multiplexing or Ethernet style connection.

The system may also be integrated into an existing third party process or plant condition monitoring system.

The system could be configured to include a multiplexed network and use field bus coupling to enable the key outputs to be transferred to remote users in an easily interpretable form.

For either of the above described alternatives, the system could be provided with user outputs, which could be in the form of key life trend graphs, relative values that relate to the level of degradation or in a more basic system could be simple red, amber or green status indicators.

The trend data for key application points may be linked using a database to other relevant information that may be needed on-line by the inspection engineers; which could be component drawings, diagrams, maintenance history, testing history, other CM history from other methods (vibration, thermograph, oil sample and so on) as well as the AE trend history data and details of the system set up.

The system could be networked to an automatic alarm system that can produce notification text messages, e-mails, automatic telephone calls, or PC alerts. The product will have suitable interfaces to enable the collected data to be transmitted with relevant notifications.

It is envisaged for some sophisticated solutions that the data derived from the monitoring functions could be linked to a system representation on a display. More specifically, there would be provided on a control computer or the like a display of apparatus and included in that display and indication of the operating condition of the various components being monitored. That display could, for example, show a coloured light by the monitored components, such as green for fine, amber for components reaching maturity and red for components operating incorrectly or approaching failure. In a simpler case, only a warning of impending failure could be provided.

FIG. 7 shows an example of what usefully could be provided to a user of the system. The Figure shows a graph giving a measure of the determined acoustic emission degradation parameter against life expectancy. A component or other element monitored would be represented on the display at the approapriate location. As will be apparent to the reader, the user can thus determine from the graph whether the component in quesiton is performing normally, whether it is performing abnormally, whether it is in a damage or breakdown region.

An example of system set up for monitoring the condition of bearings in windmills of a wind farm is shown in FIG. 8. The system includes AE sensor equipment 30, at least one data collection interface 32, data analysis processing apparatus 34, a data output interface 36 and at least one user interface 38.

Elements 30 to 34 could be contained in the proprietary product, with the interfaces 36 and 38 being tailored to customer application needs.

It will be apparent that the data collection interface will be the central part of the condition monitoring system. The data output interface 36 could be via a proprietary hand-held device or could be on its own signal network (Ethernet) to link to a client's computer network.

The user interface 38 is preferably the bespoke system interface software designed for a client's preferred output device (PC/PDM/Third party CM system and so on). The user output 38 would display the AE trend data for the particular monitored element and be capable of displaying full information on those elements, such as reading parameters (dates of readings, time settings of collection, data collection thresholds an so on). It is possible that the user interface element 38 could be third party supplied and integrated with the proprietary system elements 30 to 34.

It will be apparent that it is possible to have product off-line or on line monitoring in real time. In addition the system may be off line and of a portable nature rather than been a permanently installed system.

A summary of the functioning of this apparatus, which will be apparent to the skilled person having regard to the teachings herein, in as follows:

1) extract the timing of acoustic emission events from a signal obtained from acoustic emission sensor 30 attached to the structure or a machine in a process;

2) determine the inter-event durations, called the inter-arrival times;

3) form a distribution of the inter-arrival times;

4) fit to the distribution a statistical model

5) estimate parameters for a particular statistical distribution model; in the case of the Weibull distribution, the guaranteed life, the characteristic life and the shape factor are estimated;

6) calculate the STL and L₆₃ parameters from the three estimated Weibull parameters;

7) use the STL and L₆₃ as co-ordinates of a point on the STL-L₆₃ graph; and

8) establish the condition of the item being monitored by noting the location of the point on the STL-L₆₃ graph. The graph is divided into regions representing conditions of normal and abnormal operation of the item.

Although the above describes the use of a Weibull distributions, the invention is not limited to such. Other statistical distributions could be used, in particular any model that has been used for the analysis of times-to-failure in reliability engineering or the study of arrivals and departures in queuing theory can be suitable candidates. Typical distribution models used can be Weibull distributions, negative exponential distributions and hyper-exponential distributions.

In the preferred embodiment, the method and system provide a shape-to-life (STL) parameter having the unit (per second) based on inter-arrival times of successive acoustic emission (AE) events and defined as the ratio of the shape factor of the inter-arrival time distribution to the characteristic and guaranteed life, in the statistical distribution (L₆₃) used to describe probability of time to failure as used in reliability analysis employing the Weibull distribution.

The shape-to-life parameter is used to determine a trend with time in operational performance of a machine, process or material such as bearing wear of a rotating machine.

Preferably, the condition monitoring system provides an observable output of the shape-to-life parameter as a function of a particular cumulative probability parameter of the total number of inter-arrival times of the acoustic emission (AE) events.

The system can also provide an output indication when the parameter has changed with time by a particular mount or fraction.

In the above description of the preferred embodiments, the STL and L₆₃ values have been explored and demonstrated as sensitive condition monitoring AE parameters. The STL method is based on the modelling of inter-arrival times of AE events, preferably using the Weibull distribution. The STL is defined as the ratio of two estimated Weibull parameters, shape to characteristic life (Equation 4). The L₆₃ is defined as the summation of the estimated guaranteed life and characteristic life (Equation 5). Both the STL and L₆₃ values are influenced by wear, speed and loading.

From experiments, it has been found that the STL values remain more or less level if the bearing is subjected to the applied load within basic dynamic load rating. When the applied load becomes greater, the STL is increased whilst the L₆₃ is decreased.

The change in speed of rotating machines has been found to affect the STL values. This is because the rotating speeds and inter-arrival times are approximately inversely related. The effect of speed variations on STL can be compensated using the hyperbolic relationship between STL and L₆₃.

Similar to load and speed, STL has been found to be influenced by wear. From the progressive bearing wear test, it is clear that the progression of wear results in a monotonically increasing trend of STL. When the bearing failed to operate, the STL was increased to about 30 times the value for the initial bearing condition (FIG. 5). In order to set the threshold for STL as a bearing condition alert, the choice of threshold level is governed by the rule that the alarm level should be set no higher than five times the initial STL value of the bearing.

It has been found that the rotating speed and inter-arrival time between AE events are inversely proportional to each other, resulting in the hyperbolic relationship between STL and L₆₃. This hyperbolic curve provides the basis for adjusting STL and L₆₃ for speed compensation and load compensation.

Using a clustering technique based on the other features of AE events, besides the inter-arrival times, AE events are cast into different groups. The inter-arrival times of each individual group are given the same treatment as that described above. As each group of AE events are attributable to a common source or a set of similar sources, this refined approach permits diagnosis of possible causes that may lead to eventual failure of the material, process or machine elements.

The disclosures in British patent application no 0307312.9, form which this application claims priority, and in the abstract accompanying this application are incorporated herein by reference.

1. A method of determining the condition of a device, process, material or structure including the steps of:
a. measuring acoustic emission events from the device, process, material or structure;
b. determining inter-arrival times of the acoustic emission events;
c. determining a statistical distribution of the inter-arrival times;
d. determining from the statistical distribution statistical parameters which characterize the distribution; and
e. using the statistical parameters as an indication of the condition of the device, process, material or structure being monitored.

2. A method according to claim 1, wherein the statistical parameters are obtained using parameter estimation.

3. A method according to claim 1, wherein a Weibull distribution is used.

4. A method according to claim 1, including the step of determining a distribution of a shape to characteristic life parameter for at least one component of the device, process, material or structure.

5. A method according to claim 4, wherein the shape to characteristic life parameter is a unit based on inter-arrival times of successive acoustic emission events and is a function of the ratio of the shape factor of the inter-arrival time distribution to the characteristic and guaranteed life in a statistical distribution used to describe the probability of time to failure.

6. A method according to claim 1, including the step of monitoring trends in changes in the determined statistical parameters over time.

7. Apparatus for determining the condition of a device, process, material or structure, including:
a. at least one sensor operable to measure acoustic emission events from the device, process, material or structure to be monitored;
b. processing means for:
(1) determining a statistical distribution of the inter-arrival times of the acoustic emission events;
(2) determining from the statistical distribution statistical parameters characterising the distribution; and
(3) using the statistical parameters as an indication of the condition of the device, process, material or structure being monitored; and
c. output means to output the results of the indication to a user.

8. Apparatus according to claim 7, wherein the processing means is operable to obtain the statistical parameters using parameter estimation.

9. Apparatus according to claim 7, wherein the processing means is operable to use a Weibull distribution.

10. Apparatus according to claim 7, wherein the processing means is operable to determine a shape to characteristic life distribution for at least one component of the device, process, material or structure.

11. Apparatus according to claim 10, wherein the shape to characteristic life parameter is a unit based on inter-arrival times of successive acoustic emission events and is a function of the ratio of the shape factor of the inter-arrival time distribution to the characteristic and guaranteed life in a statistical distribution used to describe the probability of time to failure.

12. Apparatus according to claim 7, wherein the processing means is operable to monitor trends in changes in the determined statistical parameters over time.

13. Apparatus according to claim 7, wherein the output means includes at least one of:
a. a graphical display,
b. an optical display, and/or
c. an acoustic signal.

14. Apparatus according to claim 13, wherein the output means provides an alarm signal to at least one of:
a. an acoustic alert device,
b. a telephone, and
c. to an electronic mail address.

15. A method of determining the condition of a device, material or structure including the steps of:
a. measuring acoustic emission events from the device, material, or structure;
b. determining the inter-arrival times between successive acoustic emission events;
c. statistically characterizing the distribution of the inter-arrival times;
d. monitoring the statistical characteristics of the inter-arrival times; and
e. generating an alert to a user when the statistical characteristics reach a failure threshold.

16. The method of claim 15 wherein the inter-arrival times are statistically characterized as meeting a Weibull distribution.
